(19) United States
(12) Patent Application Publication
(10) Pub. No.: US 2008/0256064 A1
(43) Pub. Date: Oct. 16, 2008

(54) Pay per relevance (PPR) method, server and system thereof

(75) Inventor: Dan Grois, Omer (IL)

Correspondence Address: Dan Grois, 13A Adad street, P.O.Box 585, Omer, 84965, IL

(73) Assignee: Dan Grois, Omer (IL)

(21) Appl. No.: 12/080,939

(22) Filed: Apr. 8, 2008

(30) Foreign Application Priority Data
Apr. 12, 2007 (IL) 182518

(51) Int. Cl. G06F 7/06; G06Q 10/00; G06F 17/00; G06Q 30/00

(52) U.S. Cl. 707/5; 705/400; 705/14; 705/34; 715/253; 707/E17.108

(57) ABSTRACT

The present invention relates to a server, system and method of pricing advertisements to be presented within a document, according to their relevance to user's search query, comprising: (a) receiving from an advertiser at least one keyword, for which his advertisement to be presented to said user, or receiving and processing said user's search query that contains at least one keyword; (b) determining the relevance weight of said advertisement to said at least one keyword, according to at least one predefined parameter; and (c) pricing said advertisement according to the determined relevance weight.

### CROSS-REFERENCE TO RELATED APPLICATION(S)

The present application claims priority from Israeli Patent Application No. 182518 filed on Apr. 12, 2007, the entire disclosure of which is incorporated herein by reference.

### FIELD OF THE INVENTION

The present invention relates to advertising over a data network, such as the Internet. More particularly, the present invention relates to a method and system for pricing advertisements (e.g., sponsored links) that are presented to a Web site (e.g., search engine) user, according to their relevance to user's search query (user's one or more search keywords).

### BACKGROUND OF THE INVENTION

For the last decade, the Internet has grown significantly due to the dramatic technology developments. Surfing the Internet has become a very simple and inexpensive task, which can be afforded by everyone. Due to the ISDN® (Integrated Services Digital Network®) and ADSL® (Asymmetric Digital Subscriber Line®) technology, people surf the World Wide Web (WWW) with the speed of up to 12 Mbits per second, which allow them to obtain search results for their queries for less than a second. A number of new Web sites over the Internet, which go online every month, has also significantly increased over the last decade and each of main search engines over the World Wide Web crawls nowadays billions of documents.

The main source of monetary income for Web sites, and especially search engines, is advertising. Usually, an advertiser wishing to advertise his one or more products to search engine users, places on a search engine Web page (near the search results list presented to a user for his one or more queries) a “Sponsored Link” that is related to his product or service to be advertised, forwarding a user clicking on said “Sponsored Link” to his Web site where said user can purchase said products or services. The advertiser selects one or more keywords for which his Sponsored Link will be presented to the search engine user. Each time the user clicks on the “Sponsored Link”, the advertiser pays a predetermined sum of money to the search engine provider. This action is called “Pay Per Click” (or PPC). The more search engine users click on the Sponsored Links, the larger monetary income the search engine provider has. Alternatively, the search engine provider can charge the advertiser for a fixed (e.g., daily or monthly) sum of money for each “Sponsored Link” presented to the search engine user.

Also, advertisers can bid for the position of their advertisements (ads) within the search engine Web page: the more the advertiser pays per click, the higher his ad is located within said Web page. Such approach is disclosed in U.S. Pat. No. 6,269,361, which presents a system and method for enabling information providers using a computer network to influence a position for a search listing within a search result list generated by an Internet search engine. The network information provider influences the position for a search listing through a continuous online competitive bidding process. The bidding process occurs when the network information provider enters a new bid amount, which is preferably a money amount, for a search listing. Then the bid amount is compared with all other bid amounts for the same search term, and generates a rank value for all search listings having that search term. A higher bid by a network information provider will result in a higher rank value and a more advantageous placement.

According to the prior art, for each selected keyword, the advertiser pays the same sum of money disregarding the relevance of said keyword either to the advertised products or services, or to the contents of the advertiser Web site. Thus, the advertiser wastes his money, and this, in turn, significantly reduces his motivation to advertise on the search engine Web site. For example, it is supposed that the advertiser has an educational Web site related to the preparation for the GMAT® (Graduate Management Admissions®) and GRE® (Graduate Record Examination®) tests. Then, he can select, for example, that his Sponsored Link will be presented to a search engine user for the keywords “test”, “test preparation”, “GMAT®”, “GRE®”, “test score”, etc. The users who make a search by using the keywords “test”, “test preparation” and “test score” may be interested in other tests, such as “SAT®” (Scholastic Aptitude Test®)”, PCAT® (Pharmacy College Admission Test®), LSAT® (Law School Admissions Test®) tests, etc; on the contrary, users who make a search by using the keywords “GMAT®” and “GRE®” are interested only in these tests. Therefore, the chances that a user, who makes a search by using the keywords “test score”, would finally buy an advertised product/service after clicking on said Sponsored Link, are much lower than the chances that another user, who makes a search by using the keyword “GMAT®”, would buy such product/service. As a result, the advertiser has big expenses by paying for the needless clicks on his Sponsored Link: statistically, only 2%-3% percents of all users who click on the Sponsored Links, finally purchase advertised products or services. Of course, in order to decrease the advertising expenses, the advertiser can select only “GMAT®” and “GRE®” keywords for presenting his Sponsored Link, but if he does so, he loses many potential clients.

The present invention has many advantages over the prior art. For example, the present invention provides an efficient advertising method and system that decreases waste expenses for advertising within a search engine Web site.

Another advantage of the present invention is providing an efficient advertising method and system, wherein the pay per click cost (or the pay per impression cost and the like) of an advertisement is determined according to the relevance of the advertised product/service to one or more keywords, for which the advertisement of said product/service is presented to a search engine user.

Still another advantage of the present invention is providing an advertising method and system, wherein the advertisements that are more relevant to user's search query (one or more keywords) costs more per each user's click (or per each impression to the user), and the advertisements that are less relevant to user's search query costs less.

Still another advantage of the present invention is providing an advertising method and system, wherein the advertisements that are more relevant to user's search query are located above other advertisements (within the Sponsored Links list) that are less relevant to user's search query.

A further advantage of the present invention is providing an advertising method and system, wherein the pay per click cost (or the pay per impression cost and the like) of an advertisement is determined according to the relevance of the textual or graphical contents of the advertisement to one or more keywords, for which said advertisement is presented to a search engine user.

Still a further advantage of the present invention is providing an advertising method and system, wherein the pay per click cost (or the pay per impression cost and the like) of an advertisement is determined according to the relevance of the contents of a Web site, related to the advertised product(s)/service(s), to user's search query (the Web site to which the user is redirected when clicking on said advertisement).

Still a further advantage of the present invention is providing a method and system, which is user friendly.

Other advantages of the invention will become apparent as the description proceeds.

### SUMMARY OF THE INVENTION

The present invention relates to methods, servers, systems and program storage devices readable by machine for pricing advertisements (e.g., sponsored links) that are presented to a user, according to their relevance to user's search query (user's one or more search keywords).

The method of pricing advertisements to be presented within a document, according to their relevance to user's search query, comprises:
a) receiving from an advertiser at least one keyword, for which his advertisement to be presented to said user, or receiving and processing said user's search query that contains at least one keyword;
b) determining the relevance weight of said advertisement to said at least one keyword, according to at least one predefined parameter; and
c) pricing said advertisement according to the determined relevance weight.

According to a preferred embodiment of the present invention, the method further comprises selecting the at least one predefined parameter from one or more of the following:
a) advertisement contents;
b) advertisement title;
c) contents and/or domain name of a Web page, to which the user is redirected when clicking on said advertisement;
d) domain name of a Web page, to which the user is redirected when clicking on said advertisement;
e) category and/or subcategory of a Web page, to which the user is redirected when clicking on said advertisement;
f) at least one categorized score of a Web page, to which the user is redirected when clicking on said advertisement;
g) history of said Web page;
h) metadata of said Web page;
i) an advertising category that is selected by the advertiser; and
j) advertising statistics.

According to a preferred embodiment of the present invention, the method further comprises pricing the advertisement by determining a pay per relevance cost for each user's click on said advertisement.

According to another preferred embodiment of the present invention, the method further comprises pricing the advertisement by determining a pay per relevance cost for each impression of said advertisement to the user.

According to a particular preferred embodiment of the present invention, the method further comprises determining at least one synonym for each keyword and displaying the advertisements that are related to said synonym.

According to a preferred embodiment of the present invention, the method further comprises performing natural language processing on the at least one predefined parameter for determining the relevance weight of the advertisement to the at least one keyword.

According to another preferred embodiment of the present invention, the method further comprises placing the advertisement having a greater relevance weight above or below the advertisement having a smaller relevance weight.

According to still another preferred embodiment of the present invention, the method further comprises enabling each advertiser to select where within the document his at least one advertisement is placed.

According to a further preferred embodiment of the present invention, the method further comprises enabling each advertiser to select dimensions of his at least one advertisement.

According to still further preferred embodiment of the present invention, the method further comprises coloring the advertisements in different colors according to their relevance weight.

According to a preferred embodiment of the present invention, the method further comprises categorizing the advertisement.

According to another preferred embodiment of the present invention, the method further comprises categorizing user's search query.

According to still another preferred embodiment of the present invention, the method further comprises providing at least one category and/or subcategory, and building a dictionary of related terms for each category and/or subcategory.

According to still another preferred embodiment of the present invention, the method further comprises determining whether the user's search query is within the dictionary and then determining the relevance weight accordingly.

According to a further preferred embodiment of the present invention, the method further comprises dynamically changing the pricing of the advertisements.

The method of presenting advertisements to a user in a specific order within a document, according to their relevance to user's search query that contains at least one keyword, comprises:
a) receiving user's search query and processing it; and
b) displaying to said user at least two advertisements, which are related to said user's search query, in a corresponding order within said document according to the relevance weight of said advertisements to said user's search query, said relevance weight determined according to at least one predefined parameter.

According to a preferred embodiment of the present invention, the method further comprises pricing the advertisements according to the determined relevance weight.

The method of presenting advertisements to a user in a specific order, according to their relevance to the contents of a document on which they are presented, comprises:
a) analyzing the document contents and determining at least two advertisements related to said contents;
b) determining the relevance weight of each of said at least two advertisements to said document contents, according to at least one predefined parameter; and
c) displaying on said document said at least two advertisements, in a corresponding order according to the determined relevance weight of each of said at least two advertisements to said document contents.

The server configured to provide advertisements according to users' search queries, each of said search queries containing at least one keyword, said server comprises:
a) an advertisements database for storing a plurality of advertisements, each to be provided to the user according to his search query containing at least one keyword; and
b) a pay per relevance software component for determining, according to at least one predefined parameter, a relevance weight of each advertisement stored within said advertisements database to said at least one keyword, and for pricing said each advertisement according to the determined relevance weight.

According to a preferred embodiment of the present invention, the server further comprises a search data database for storing a plurality of documents to be provided as search results to users' search queries.

According to another preferred embodiment of the present invention, the server further comprises at least one additional software component for performing at least one of the following:
a) managing the search data database;
b) receiving and processing users' search queries; and
c) providing to said users corresponding search results from said search data database.

According to still another preferred embodiment of the present invention, the server further comprises at least one additional software component for managing the advertisements database and for processing advertisements to be presented to the users.

According to still another preferred embodiment of the present invention, the server further comprises a billing unit for enabling billing of advertisers for providing their advertisements to users, according to the determined relevance weight.

According to a preferred embodiment of the present invention, the at least one predefined parameter is selected from one or more of the following:
a) advertisement contents;
b) advertisement title;
c) contents and/or domain name of a Web page, to which the user is redirected when clicking on said advertisement;
d) domain name of a Web page, to which the user is redirected when clicking on said advertisement;
e) category and/or subcategory of a Web page, to which the user is redirected when clicking on said advertisement;
f) at least one categorized score of a Web page, to which the user is redirected when clicking on said advertisement;
g) history of said Web page;
h) metadata of said Web page;
i) an advertising category that is selected by the advertiser; and
j) advertising statistics.

According to a preferred embodiment of the present invention, for pricing the advertisement, a pay per relevance cost for each user's click on said advertisement is determined.

According to another preferred embodiment of the present invention, for pricing the advertisement, a pay per relevance cost for each impression of said advertisement to the user is determined.

According to still another preferred embodiment of the present invention, at least one synonym is determined for each keyword.

According to a further preferred embodiment of the present invention, the server enables displaying the advertisements that are related to the at least one synonym.

According to a preferred embodiment of the present invention, the natural language processing is performed on the at least one predefined parameter for determining the relevance weight of the advertisement to the at least one keyword.

According to another preferred embodiment of the present invention, the server provides, within a sponsored links list, the advertisement having a greater relevance weight above or below the advertisement having a smaller relevance weight.

According to still another preferred embodiment of the present invention, the server enables each advertiser to select where within a sponsored links list his at least one advertisement is placed.

According to still another preferred embodiment of the present invention, the server enables each advertiser to select dimensions of his at least one advertisement.

According to a further preferred embodiment of the present invention, the server enables coloring the advertisements in different colors according to their relevance weights.

According to still a further preferred embodiment of the present invention, the server enables categorizing each advertisement to its corresponding category and/or subcategory.

According to still a further preferred embodiment of the present invention, the server enables categorizing the user's search query to its corresponding category and/or subcategory.

According to a preferred embodiment of the present invention, the server enables providing at least one category and/or subcategory, and enables building a dictionary of related terms for each category and/or subcategory.

According to a preferred embodiment of the present invention, the server determines whether the user's search query is within the dictionary, and then determines the corresponding relevance weight.

According to a preferred embodiment of the present invention, the server enables dynamically changing the pricing of each advertisement.

The system configured to price advertisements according to their relevance to user's search queries, each of said search queries containing at least one keyword, said system comprises:
a) a plurality of computers connected to a Web site over a data network for enabling users to search said Web site or said data network by using at least keyword; and
b) a server configured to provide advertisements to said users according to their search queries, each of said search queries containing at least one keyword, said server comprising:
   b.1. an advertisements database for storing a plurality of advertisements, each to be provided to the user according to his at least one keyword; and
   b.2. a pay per relevance software component for determining, according to at least one predefined parameter, a relevance weight of each advertisement stored within said advertisements database to said at least one keyword, and for pricing said each advertisement according to the determined relevance weight.

The program storage device readable by machine, tangibly embodying a program of instructions executable by the machine to perform a method of pricing advertisements to be presented within a document, according to their relevance to user's search query, comprises:
a) receiving from an advertiser at least one keyword, for which his advertisement to be presented to said user, or receiving and processing said user's search query that contains at least one keyword;
b) determining the relevance weight of said advertisement to said at least one keyword, according to at least one predefined parameter; and
c) pricing said advertisement according to the determined relevance weight.

According to a preferred embodiment of the present invention, the document is a Web page.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a method for pricing advertisements presented to a search engine user according to their relevance to a search query of said user, according to a preferred embodiment of the present invention;

FIG. 2 illustrates a sample User Interface for placing an advertisement (Sponsored Link) within a search engine Web site, according to a preferred embodiment of the present invention;

FIG. 3 is a schematic illustration of setting the PPR click costs for an advertisement (Sponsored Link) to be displayed within a search engine Web site, according to a preferred embodiment of the present invention;

FIG. 4 is a schematic illustration of setting the PPR click costs of an advertisement to be displayed within a search engine Web site in a desired advertising position within Sponsored Link list, according to a preferred embodiment of the present invention;

FIG. 5 is a schematic illustration of system for the PPR advertising over a data network, according to a preferred embodiment of the present invention; and

FIG. 6 is another schematic illustration of a method for the PPR advertising over a data network, according to another preferred embodiment of the present invention.

### DETAILED DESCRIPTION OF THE PREFERRED EMBODIMENTS

In the following detailed description, numerous specific details are set forth in order to provide a thorough understanding of the invention. However, it will be understood by those skilled in the art that the present invention may be practiced without these specific details. In other instances, well-known methods, systems, procedures, components, circuits and the like have not been described in detail so as not to obscure the present invention.

Hereinafter, when the term “document” is used it should be noted that it also relates to the terms “page”, “Web page”, “Web site” and the like, which are used interchangeably. The term “document” can be broadly interpreted as any machine-readable and machine-storable work product. A document may include an e-mail, a web site, a file, a combination of files, one or more files with embedded links to other files, a news group posting, a blog, a web advertisement, etc. In the context of the World Wide Web (WWW), a common document is a web page. Web pages often include textual information and may include embedded information (such as meta information, hyperlinks, images, pictures, graphics, etc.) and/or embedded instructions (such as the JavaScript™, etc.). A page may correspond to a document or a portion of a document and vise versa. A page may also correspond to more than a single document and vise versa.

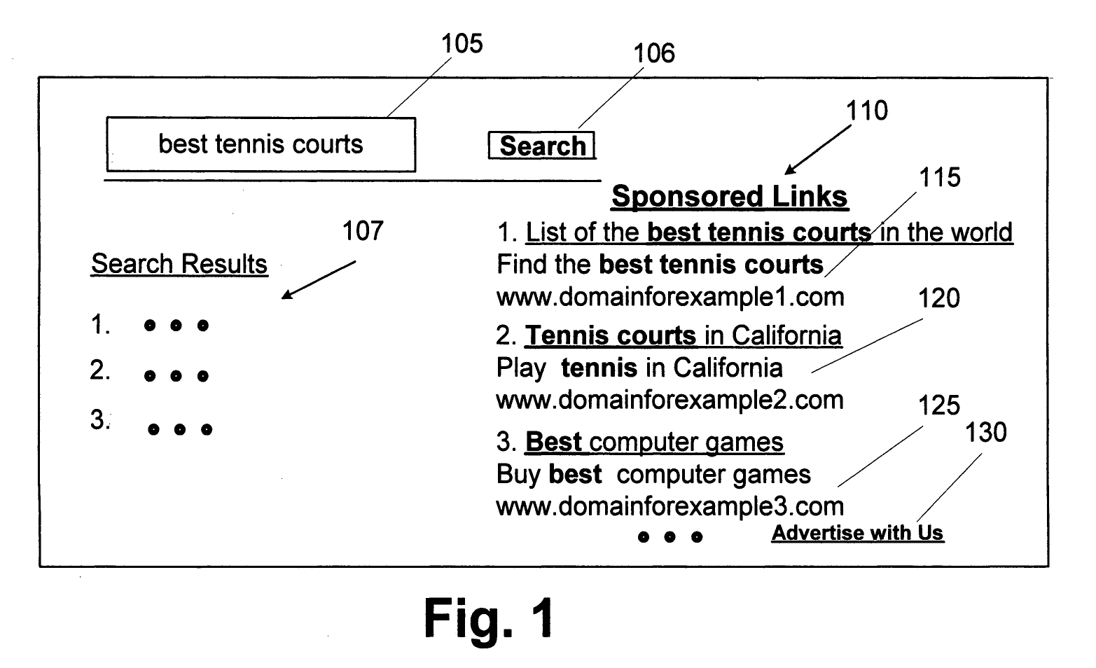

FIG. 1 illustrates a method for pricing advertisements presented to a search engine user according to their relevance to a search query (one or more keywords) of said user, according to a preferred embodiment of the present invention. The user enters his search query, such as the “best tennis courts” into a corresponding text filed 105 and presses a “Search” button 106. Then, one or more Sponsored Links (advertisements) are presented to the user along with non-sponsored search results 107. The Sponsored Links are organized such way that the advertisements that are more relevant to user's search query are placed at higher positions than the less relevant advertisements. Thus, for the query “best tennis courts”, advertisement 115 is the most relevant, presenting to the user a list of the best tennis courts in the world; advertisement 120 is less relevant than advertisement 115, presenting to the user tennis courts in California only; and advertisement 125 is less relevant than advertisement 120, and it presents to the user best computer games, and it may be not related to the tennis courts (or tennis computer games) at all.

According to a preferred embodiment of the present invention, the relevance of an advertisement to each user's search query can be determined according to one or more of the following parameters: advertisement contents (e.g., its textual and/or graphical/image contents); advertisement title; contents and/or domain name of a Web page, to which the user is redirected when clicking on said advertisement; history and/or metadata (such as title, description, author name, update date, etc.) of said Web page; etc. For each of the above parameters, a predefined relevance weight (RW) is assigned to each advertisement for each selected keyword (for which said advertisement is presented). For example, if 0≦RW≦1, then the RW for advertisement contents can be 0.4; the RW for the advertisement title can be 0.15; the RW for the contents and/or domain name of a Web page, to which the user is redirected when clicking on said advertisement can be 0.25; and the RW for the history and/or metadata of said Web page can be 0.2.

According to a preferred embodiment of the present invention, for determined the relevance of the advertisement to each user's search query (containing one or more keywords), the following factors (parameters) are further considered:
whether the advertisement contents/advertisement title contains said one or more keywords, or their synonyms, or related keywords (terms); if they contain (the more frequent—the better until a predefined number of times (e.g., five times)), it contributes to the relevance weight;
whether the contents and/or domain name of a Web page, to which the user is redirected when clicking on said advertisement, contain said one or more keywords, or their synonyms, or related keywords; if they contain (the more frequent—the better until a predefined number of times (e.g., ten times)), it contributes to the relevance weight; further, if the one or more keywords, or their synonyms, or related keywords are located in the header of said Web page, it contributes even more to the relevance weight.
whether history and/or metadata (such as title, description, author name, update date, etc.) of said Web page, to which the user is redirected when clicking on said advertisement, contain said one or more keywords, or their synonyms, or related keywords; if they contain, it contributes to the relevance weight;
whether the advertisement can be (or is) classified to the same category or subcategory as said one or more keywords; if yes, it contributes to the relevance weight;
whether said Web page, to which the user is redirected when clicking on said advertisement, can be (or is) classified to the same category or subcategory as said one or more keywords; if yes, it contributes to the relevance weight; etc.

According to a preferred embodiment of the present invention, the relevance of an advertisement to each user's search query (one or more keywords) can be determined in real-time and/or in off-line.

In real-time, when the search engine user (or any other Web site user) searches a data network (or makes a search within a conventional Web site over said data network) by using one or more keywords, the search engine provider automatically determines the relevance (weight) of advertisements placed on its Web site to said one or more keywords. The relevance weight is determined according to the one or more predefined parameters (such as advertisement contents; advertisement title; contents and/or domain name of a Web page to which the user is redirected when clicking on said advertisement; history and/or metadata (such as title, description, author name, update date; etc.) of said Web page; etc. Then, the search engine provider automatically determines how much the advertiser will pay each time the user clicks on his advertisement—the PPR click cost (or each time the advertisement is displayed to the user—the PPR impression cost). As a result, the advertiser pays per relevance (PPR) of his advertisement to user's search keywords.

In off-line, when placing an advertisement on a search engine Web site, the advertiser selects one or more search queries (keywords) for which his advertisement will be displayed. Then, in off-line, the search engine provider automatically determines according to the one or more predefined parameters (such as advertisement contents; advertisement title; contents and/or domain name of a Web page to which the user is redirected when clicking on said advertisement; history and/or metadata (such as title, description, author name, update date; etc.) of said Web page; etc.) how much the advertiser will pay each time the user clicks on his advertisement (or each time the advertisement is displayed to the user). The more the selected keywords are relevant to the above one or more predefined parameters (and to the advertised products or services), then the more the advertiser will pay for each click on his advertisement, and the higher his advertisement will be located within Sponsored Links list 110. As a result, the advertiser pays per relevance (PPR) of his advertisement to search keywords. For example, the PPR click cost for advertisement 115 can be $0.5; the PPR click cost for advertisement 120 can be $0.3; and the PPR click cost for advertisement 125 can be $0.05. Because the relevance of advertisement 125 to the query “best tennis courts” is relatively low, then the cost per click is also low.

Further, when user press on the “Advertise with Us” link 130, he is redirected to a process for placing his advertisement (Sponsored Link) within a Sponsored Links list 110 on a search engine Web site.

According to a preferred embodiment of the present invention, the relevance of an advertisement to each user's search query can be determined according to one or more categorized scores of a Web page, to which the user is redirected when clicking on said advertisement. Said categorized scores indicate the category and/or subcategory, to which said Web page is assigned. Assigning the one or more categorized scores to a document stored within a database over a data network is described in the patent application PCT/IL2006/001427.

It should be noted that the search engine provider (or any other Web site/page provider, such as a Web portal provider, Web forum provider, Web auction provider and the like) can further determine the PPR cost of each advertisement (indicating how much the advertiser pays each time the user clicks on his advertisement or each time the advertisement is displayed to said user) and corresponding position of said each advertisement within the Sponsored Links 110 list, according to the advertising statistics (or to the historical data). Such statistics (or historical data) can be based on various parameters, such as the advertisement display time (e.g., each Wednesday from 16.00 to 21.00 o'clock), sector to which the advertisement is directed (e.g., private, industrial, business, academic), demographic and geographic characteristics of users, to which the advertisement is directed and the like. For example, if the advertisement is displayed on Sunday, then its advertising PPR (Pay-Per-Relevance) cost can be lower than if said advertisement would be displayed on Monday, since on Sundays, statistically, there are less users that surf over the data network, such as the Internet. Similarly, the PPR cost for advertising each day around the midnight can be lower than the PPR cost for advertising each day around the noon time.

According to a preferred embodiment of the present invention, the search engine provider (or any other provider) can dynamically change the PPR advertising cost (and corresponding position of the advertisement within the Sponsored Links 110 list) according to varying parameters, such as advertising time during the day or night, etc. Thus, the PPR advertising cost at night (e.g., between 23.00 and 6.00 o'clock) can be automatically decreased, and the PPR advertising cost at day (e.g., from 6.00 o'clock) can be automatically increased. As a result, the PPR advertising cost for one advertiser, for example, can vary from $1 to $10 at day (e.g., $2 at 7.00 o'clock, $10 at 20.00 o'clock and $3 at 23.00 o'clock) and from $0.1 to $2 at night (e.g., $0.1 at 4.00 o'clock and $0.4 at 5.30 o'clock in the morning). According to a preferred embodiment of the present invention, such change in the PPR advertising cost (and corresponding change in position of the advertisement within the Sponsored Links 110 list) can be performed by means of a software component (not shown) installed on the advertiser's computer. Such software component can be provided from a 3-rd party company, and downloaded (or, for example, bought in a shop) by each advertiser from the Web site of said 3-rd party company. The advertiser can set by means of said software component the various parameters, according to which the PPR cost of his advertisement (and corresponding position of his advertisement within the Sponsored Links 110 list) will be changed. The software component can connect (and log-in) from advertiser's computer to said search engine provider's Web site, and then change in real-time said PPR cost and said corresponding position of the advertiser's advertisement. According to this preferred embodiment, each advertiser can manage various settings of his advertisement directly on his computer, and said 3-rd party company can receive royalties from each user's click on said advertisement. For example, if the PPR (Pay-Per-Relevance) cost is $2.2, then said $2.2 are paid by an advertiser to the search engine provider, on whose Web site the corresponding service or product is advertised (or any other provider, which provides/displays said advertisement to users), and %10 of $2.2 (22 cents) are, in addition, paid by said advertiser to said 3-rd party company. Thus, the advertiser pays $2.42 ($2.2+$0.22=$2.42) for each user's click. According to another preferred embodiment of the present invention, the software component is provided online via the search engine provider's (or any other provider's) Web site. Thus, the advertiser after logging-in into said provider's Web site, can set by means of said software component the various parameters, according to which the PPR cost of his advertisement (and corresponding position of his advertisement within the Sponsored Links 110 list) will be changed. The software component can change in real-time said PPR cost and said corresponding position of the advertiser's advertisement. According to this preferred embodiment, said software component can be provided by means of said search engine provider.

According to a preferred embodiment of the present invention, the demographic statistics of destination users (to which the advertisement is directed) can be related to users' race, age, income, disabilities, mobility (e.g., in terms of the travel time to work or a number of vehicles available), educational attainment, home ownership, employment status, etc. Thus, for example, if the advertisement is directed to teenagers, then it may be placed on the top of the Sponsored Links 110 list, since the teenagers, generally, are tending to click on advertisements that they see first. Similarly, the advertisements that are directed to impulsive people (of any age), can be also placed on the top (or within first several advertising spaces) of said Sponsored Links 110 list.

According to another preferred embodiment of the present invention, the geographic location of each destination user (to which the advertisement is directed) is also considered, when calculating the corresponding PPR click cost and determining an (optimal) advertisement position within the Sponsored Links 110 list. Thus, for example, if the advertisement is directed to Brazilians and is related to meat meals, then its PPR click cost can be higher than the PPR click cost of the advertisement that is also related to meat meals, but directed to Italians, since Brazilians like eating meat much more than Italians. In addition, such advertisements directed to Brazilians can be positioned higher within the Sponsored Links 110 list, then the advertisements directed to Italians. It should be noted that users' geographic location can be determined according to their computer IP (Internet Protocol) addresses.

According to still another preferred embodiment of the present invention, when calculating the PPR click cost and determining a position of an advertisement within the Sponsored Links 110 list, the recommendations and popularity (over the data network) of the service or product to be advertised in said advertisement are considered. Such recommendations can be provided within Web social networks, Web forums, billboards, auctions, blogs and the like. From said social networks and the like, the popularity of said service or product can be further determined. For example, it is supposed that the advertised product is Sony® PlayStation III® that is highly recommended in social networks and blogs by means of many Web users. Thus, the corresponding PPR click cost for advertising of the Sony® PlayStation III® can be relatively high, since that the probability that the user that clicks on this advertisement will buy the advertised product (Sony® PlayStation III®) is also relatively high. Similarly, the optimal position of said advertisement within the Sponsored Links 110 list can be on the top of said Sponsored Links 110 list (or for example, within the top several advertising spaces) for the same reasons. It should be noted that the recommendations and service/product popularity, provided over cellular network, cable network, satellite network, Ethernet and any other data network, can also be considered.

Further, according to a preferred embodiment of the present invention, when considering the recommendations and popularity for calculating the corresponding PPR click cost and determining an (optimal) position of an advertisement within the Sponsored Links 110 list, conventional natural language processing techniques can be implemented for enabling a semantic analysis of said recommendations and determining corresponding popularity. In addition, conventional image recognition techniques can be implemented for analyzing images/videos related to each recommendation of the product or service. Thus, if an image with a smiling face refers to a good recommendation and an image with a laughing face refers to a very good recommendation (indicating that the user is very pleased with the product or service, which he recommends), then the image recognition unit provided within the search engine provider's server (or any other provider's server) analyzes said image and classifies it: e.g., whether it is a good or very good recommendation. After that, a corresponding PPR click cost and position of the advertisement within the Sponsored Links 110 list are determined accordingly.

Also, each service and product can receive a popularity/recommendation rank (weight), indicating its corresponding popularity and recommendations. For example, if the above Sony® PlayStation III® has rank “90” out of “100”, then it means that it is very popular and highly recommended.

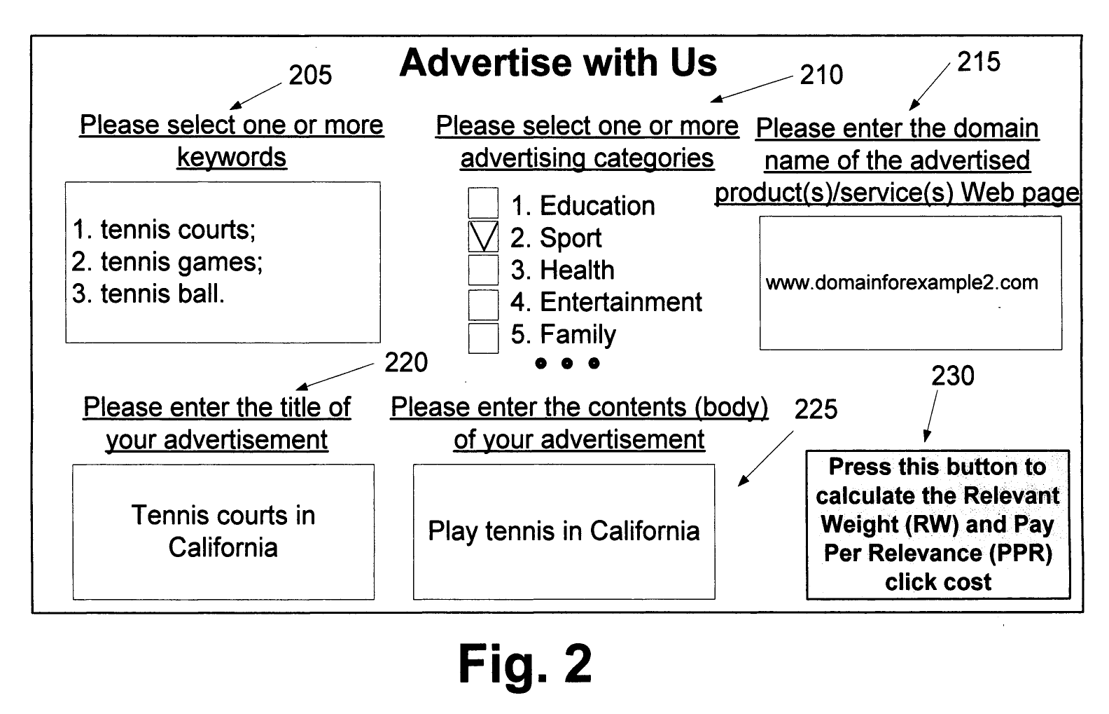

FIG. 2 illustrates a sample User Interface for placing an advertisement (Sponsored Link) within a search engine Web site, according to a preferred embodiment of the present invention. In a text field 205, the advertiser defines one or more keywords (such as “tennis”, “courts” and “best”) for which his advertisement will be displayed to a search engine user. Then, the user selects corresponding one or more categories (or subcategories) 210, to which his advertisement is related. For example, if he selects a Sport category, then the PPR click cost will be calculated according to a predefined tariff of said Sport category. The tariff can be based on a plurality of factors, such as the popularity of each category and/or subcategory; a number of subcategories in each category; a relevance (or importance) of a corresponding keyword to said category and/or subcategory; etc. Thus, the advertising in categories (or subcategories) that are more popular among search engine user can cost more than advertising in less popular categories (or subcategories). It should be noted that for each keyword (indicated in text field 205) can be defined its corresponding one or more categories (or subcategories). Also, it should be noted that if an advertiser selects an inappropriate category and/or subcategory 210 (that is not related at all to the advertised product(s) and/or service(s)) on purpose in order to get a lower PPR click cost, he can be banned from advertising on the search engine Web site.

At the text field 215, the advertiser enters domain name of the advertised product(s)/service(s) Web page, such as www.domainforexample2.com, to which the search engine user is redirected after clicking on the advertisement. After that, the advertiser provided the title and the contents (body) of his advertisement in the text fields 220 and 225, respectively. Finally, after inserting all details, the advertiser presses button 230 for calculating the PPR costs of his advertisement according to each keyword indicated in text field 205. The search engine provider automatically calculates the PPR click costs (or the PPR impression cost—for each impression of the advertisement to the search engine user) by means of a software component(s) installed within its server, and then displays them to the advertiser. The calculated PPR click costs are based on one or more of the following parameters, according to which a predefined relevance weight (RW) is assigned: advertisement contents; advertisement title; contents and/or domain name of an advertised product(s)/service(s) Web page (to which the user is redirected when clicking on said advertisement); history and/or metadata of said Web page; etc.

After the PPR click costs are displayed to the advertiser, he can decide whether to increase or decrease each of these costs. For example, if the PPR click cost of advertisement 120 (FIG. 1) for the keyword “tennis courts” is $2 per click, the advertiser may wish to decrease it to $1 per click. However, if he does so, his advertisement 120 can be displayed at a lower position within Sponsored Links list 110 (FIG. 1). For example, it will be displayed below advertisement 125. According to a preferred embodiment of the present invention, if he increases the PPR click cost to $10 per click for example, then his advertisement can be displayed at the top of said Sponsored Links list 110 and above all advertisements for which a lower per click rate is paid (even if said advertisements are more relevant to users' search queries (such as “tennis courts”) than advertisement 120 is).

According to another preferred embodiment of the present invention, the advertisers of more relevant advertisements pays less money than advertisers of less relevant advertisements for placing their advertisements into the same advertising position within Sponsored Links list 110. For example, advertisement 125 is less relevant to the keywords “best tennis courts” (as shown on FIG. 1) than advertisement 120. Therefore, the PPR click cost of advertisement 120 is greater than the PPR cost of advertisement 125, which can be $0.3 and $0.05, respectively. If the advertiser of said advertisement 125 wishes to place it on the top position within Sponsored Links list 110 (above advertisement 115 (FIG. 1)), then he can be required to pay $1 per click. On the other hand, the advertiser of advertisement 120 for to placing said advertisement 120 on said top position can be required to pay $0.7 per click. By this way, the search engine provider can insure with a greater probability that the more relevant advertisements are displayed at top positions of Sponsored Links list 110.

According to still another preferred embodiment of the present invention, the advertiser of advertisement 125 for placing it on the top position within Sponsored Links list 110 (above advertisement 115 (FIG. 1)) can be required to pay $0.7 per click, and the advertiser of advertisement 120 for to placing advertisement 120 on said top position can be required to pay $1 per click.

According to a preferred embodiment of the present invention, when the advertiser presses button 230, the recommended (optimal) PPR cost of his advertisement for each keyword (indicated by the advertiser within text field 205) is calculated. Thus, for the keywords “tennis courts” the PPR cost can be $0.5, for the keywords “tennis games” the PPR cost can be $0.3, and for the keywords “tennis ball” the PPR cost can be $0.1. When a search engine user searches the Web by using one or more of the above keywords, then the above advertisement is displayed within Sponsored Link list 110. If the user for example, inserts into the text field 105 (FIG. 1) the phrase “playing a tennis game on a tennis court in New-York”, then the corresponding PPR cost is calculated in real-time (or recalculated), and said advertisement is displayed within said Sponsored Link list 110.

The advertisements can be organized within said list 110 by a variety of ways. According to a preferred embodiment of the present invention, the advertisement with a larger RW (relevance weight) can be located higher in the list. Thus, the more relevant the advertisement is, the higher in the list it is located. According to another preferred embodiment of the present invention, the advertisement with a larger PPR click cost can be located higher in the list. According to still another preferred embodiment of the present invention, the advertiser can define at which advertising position he wishes his advertisement to be displayed (e.g., on the top of the Sponsored Links list, on the 3-rd position from the top and the like). For each position, the advertiser is provided with a corresponding PPR click cost. PPR click cost can be dynamically changed by the search engine provider in order to keep displaying the advertisement within the desired position. Such, for example, if another advertiser also wishes to place his advertisement at the top of the Sponsored Links list 110, then the advertisement for which the greater PPR click cost is paid (according to the maximal PPR click cost set by each advertiser), is placed on the top.

It should be noted that according to a preferred embodiment of the present invention, when the advertiser inserts one or more keywords into text field 205, one or more synonyms (or related terms/keywords) of these keywords are automatically determined by means of the search engine provider. Then, the advertisement (such as advertisement 120), for which the above keywords have been inserted, is presented to the search engine user also when said user searches the Web by using said synonyms. In addition, these synonyms can be shown to the advertiser, and the advertiser can select for which synonyms he wishes his advertisement to be displayed, and for which not.

According to a preferred embodiment of the present invention, the relevance weight of the advertisement to user's search query is determined by means of conventional natural language processing techniques and algorithms. By means of these techniques, the advertisement contents; advertisement title; contents and/or domain name of a Web page, to which the user is redirected when clicking on said advertisement; history and/or metadata (such as title, description, author name, update date, etc.) of said Web page; and other parameters are analyzed by means of a software component provided within the search engine provider's server, and then a relevance weight (RW) is assigned to the advertisement for one or more keywords or their determined synonyms (for which said advertisement is presented to a search engine user), said one or more keywords indicated by the advertiser within text field 205. According to another preferred embodiment of the present invention, the relevance weight is assigned to the advertisement for user's search query in real-time.

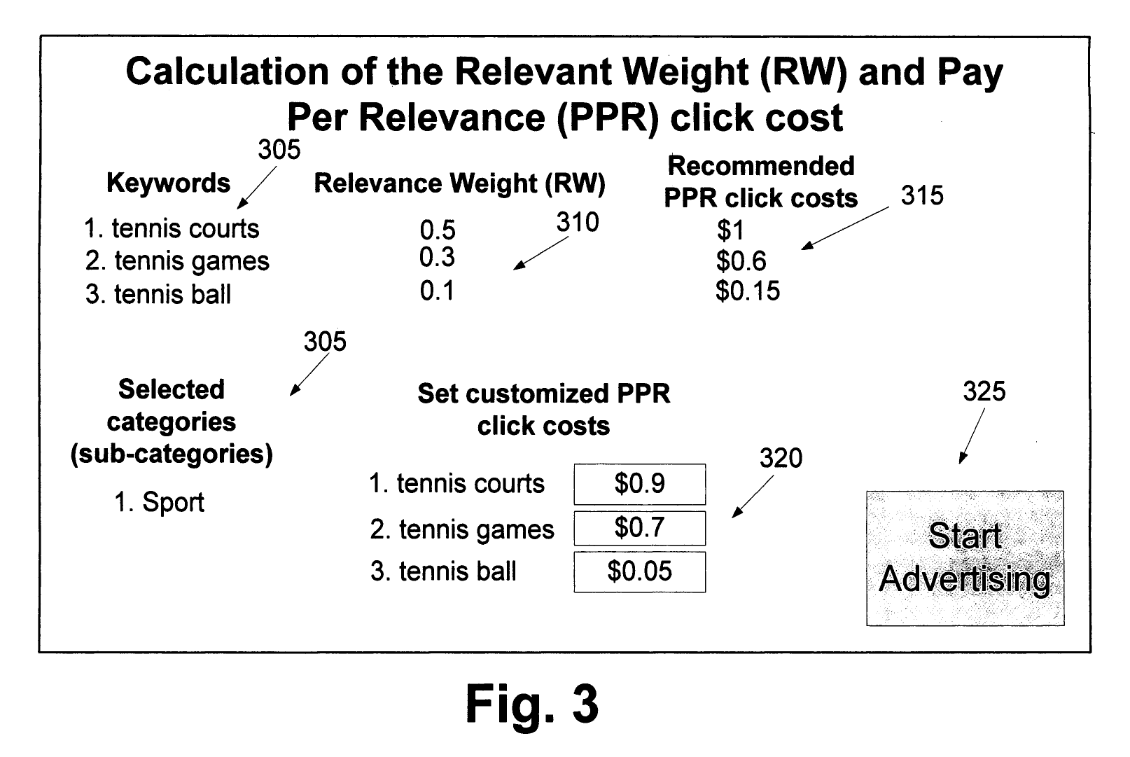

FIG. 3 is a schematic illustration of setting the PPR click costs for an advertisement (Sponsored Link) to be displayed within a search engine Web site, according to a preferred embodiment of the present invention. After the advertiser presses button 230 (FIG. 2), the search engine provider calculates relevance weights of his advertisement relative to each keyword provided by the advertiser within text field 205 (FIG. 2), according to one or more predefined parameters (such as advertisement contents; advertisement title; contents and/or domain name of a Web page, to which the user is redirected when clicking on said advertisement; history and/or metadata of said Web page; advertising one or more categories and/or subcategories 210 (FIG. 2); etc.). In addition, the search engine provider calculates and provides to the advertiser recommended (optimal) PPR click costs for each keyword (e.g., for the keywords “tennis courts”, “tennis games”, tennis ball”). The greater the RW (Relevance Weight) is, the greater the PPR click cost can be.

According to a preferred embodiment of the present invention, the advertiser can set his customized PPR click costs for each selected keyword. He can increase or decrease the PPR click cost if he wishes so. For example, for the keywords “tennis courts”, the advertiser may wish to decrease it to $0.9 per click. However, if he does so, his advertisement 120 will be displayed at a lower position within the Sponsored Links list 110 (FIG. 1). For another example, for the keywords “tennis games”, the advertiser may wish to increase the PPR click cost to $0.7 per click. Then, advertisement 120 may be displayed higher than advertisement 115 (FIG. 1) within Sponsored Links list 110 (FIG. 1), if the PPR click cost of said advertisement 115 is lower than $0.7.

When the advertiser presses “Start Advertising” button 325, his advertisement can be displayed within the search engine Web site for the keywords predefined by means of the advertiser in text field 305 or for synonyms of such keywords (or for related keywords/terms). According to another preferred embodiment of the present invention, his advertisement can be displayed within the search engine Web site for relevant user's queries; said relevance is determined by the search engine provider in real-time.

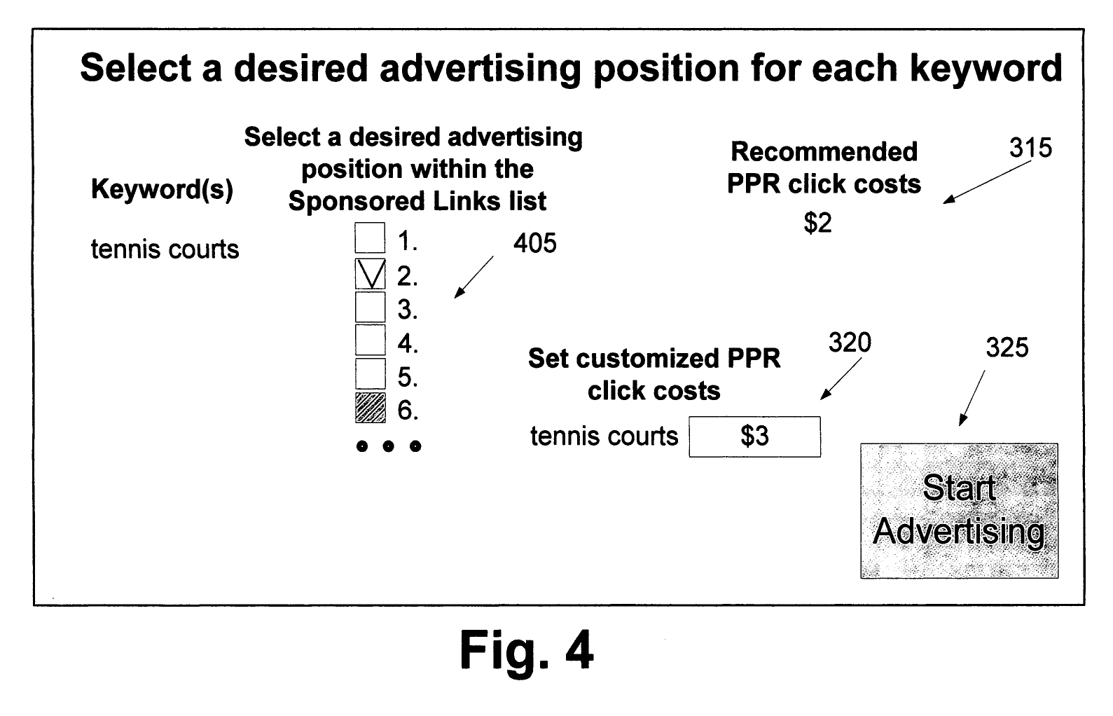

FIG. 4 is a schematic illustration of setting the PPR click costs of an advertisement to be displayed within a search engine Web site in a desired advertising position within Sponsored Link list 110 (FIG. 1), according to a preferred embodiment of the present invention. It is supposed that the recommended (optimal) advertising position, determined by means of the search engine provider according to the relevance of said advertisement to one or more keywords (such as to keywords “tennis courts”), is number 6. The advertiser can select another desired advertising position (e.g., the 2-nd position) within Sponsored Link list 110, in which he wishes his advertisement to be displayed. Then, the corresponding recommended PPR click cost (for placing the advertisement into the 2-nd position) is automatically displayed to the advertiser. The advertiser can decrease or increase PPR click costs upon the need. Finally, when the advertiser presses “Start Advertising” button 325, his advertisement is displayed within the search engine Web site for the predefined keywords (e.g., “tennis courts”) and/or for other non-predefined related keywords (or their synonyms), by which the user searches a data network. It should be noted that the relevance of the advertisement to said non-predefined related user's keywords is determined in real-time.

For example, it can be supposed that advertisement 115 and advertisement 120 are displayed for keywords “tennis courts” in 5-th and 6-th positions, respectively. Also, it is supposed that RW (Relevance Weight) of advertisement 115 and advertisement 120 to said keywords is 0.8 and 0.6, respectively. Then, according to a preferred embodiment of the present invention, if the advertiser wishes to place advertisement 115 at 2-nd position, the PPR click cost for said advertisement 115 will be $2; on the other hand, if he wishes to place advertisement 120 at 2-nd position, the PPR click cost for said advertisement 120 will be $1.5. Because advertisement 120 is less relevant (related) to keywords “tennis courts” than advertisement 115 is, the chances that the search engine user will click said advertisement 120 and/or will buy the advertised product(s)/service(s) are lower than the same for advertisement 115. Thus, the PPR click cost of advertisement 120 is also lower than that of advertisement 115.

According to another preferred embodiment of the present invention, the PPR click cost for placing advertisement 120 into the 2-nd position is larger than PPR click cost for advertisement 115. Thus, the search engine provider can ensure with a greater probability that advertisements are ordered within Sponsored Links list 110 (FIG. 1) according to their relevance to users' search queries (the more relevant advertisements are located higher within said Sponsored Links list 110).

According to still another preferred embodiment of the present invention, the advertisers bid for placing their advertisements within a specific advertising position. The advertisement of the advertiser who has placed a larger bid is displayed in a desired advertising position.

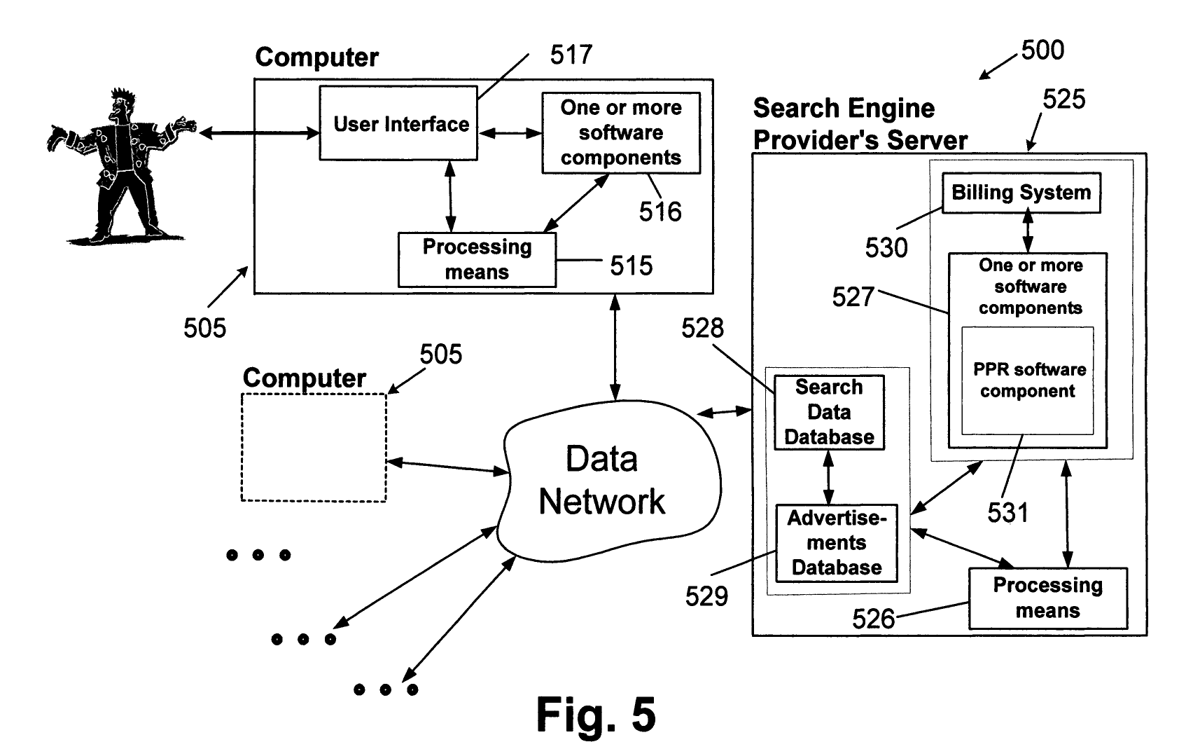

It should be noted that according to a preferred embodiment of the present invention, the advertisement can be of any type, such as textual, image, picture, graphics, video, audio, multimedia, logo, etc. If an advertisement is an image, picture, graphics, video and the like, one or more software components 527 (FIG. 5) provided within the search engine provider's server 525 (FIG. 5) analyze it, and by using conventional recognition techniques and algorithms determine what product and/or service are advertised. Then, according to a preferred embodiment of the present invention, the relevance weight (and, in turn, the PPR cost) of said advertisement to one or more keywords, predefined by the advertiser, is determined. According to another preferred embodiment of the present invention, the relevance weight (and, in turn, the PPR cost) of said advertisement to one or more user's keywords is determined in real-time.

It should be noted that according to still another preferred embodiment of the present invention, instead of the PPR click cost, a PPR impression cost is determined. According to this preferred embodiment, the advertiser pays for each impression of his advertisement to the search engine user. The PPR impression cost is determined similarly to determining the PPR click cost, according to the relevance of the advertisement to user's search query.

According to a preferred embodiment of the present invention, the data network can be of any type, such as the Internet, WWW (World Wide Web), LAN (Local Area Network), Ethernet, Intranet, cellular or wireless network, cable network, satellite network, etc.

FIG. 5 is a schematic illustration of system 500 for the PPR advertising over a data network, according to a preferred embodiment of the present invention. System 500 comprises a plurality of computers 505 and a server 525 of a search engine/database provider. Computers 505 are connected to server 525 via a data network, such as the Internet, LAN (Local Area Network), Ethernet, Intranet, wireless (mobile) network, cable network, satellite network and any other network. Each computer 505 comprises processing means (processor) 515, such as the CPU (Central Processing Unit), DSP (Digital Signal Processor), microprocessor, etc. with one or more memory units for processing data; User Interface 517 for enabling a user to conduct a data search within a database 528 by receiving from said user one or more search queries and presenting to said user one or more search results along with corresponding advertisements (stored within Advertisement Database 529); and one or more software components 516 for: processing said one or more search queries; communicating with server 525 of a search engine provider; and presenting to said user the one or more search results and advertisements for his one or more search queries.

Server 525 of a search engine/database provider comprises processing means (processor) 526, such as the CPU (Central Processing Unit), DSP (Digital Signal Processor), microprocessor, etc. with one or more memory units for processing data; a search data database 528 for storing a plurality of documents (e.g., Web pages); an advertisements database 529 for storing a plurality of advertisers' advertisements, such as Sponsored Links, etc.; one or more software components 527 for: (a) enabling advertisers to place advertisements within the search engine Web site; (b) receiving users' search queries and processing them; (c) determining (in off-line and/or in real-time) the relevance weight (RW) of the advertisements to said users' search queries and calculating (in off-line and/or in real-time) their corresponding PPR (pay per relevance) cost by means of a PPR software component 531; and (d) determining and sending to users' computers the one or more search results and advertisements (retrieved from Search Data Database 528 and Advertisements Database 529, respectively) for their search queries. Further, server 525 comprises a billing system (unit) 530 for billing advertisers for their advertisements provided to the search engine users. Each time the search engine user clicks on each advertisement within Sponsored Link list 110 (FIG. 1), the advertiser pays a predetermined sum of money to the search engine provider, according to the determined PPR click cost. The more clicks are made by means of search engine users, the larger monetary income is obtained by the search engine provider. In addition, the search engine provider can charge the advertiser for each impression of his advertisement to the search engine user, according to the determined PPR impression cost. Also, the search engine provider can charge the advertiser a fixed (e.g., daily, weekly or monthly) sum of money for each advertisement provided to the search engine user, said fixed sum of money determined according to the relevance (weight) of the advertisement to users' search queries (the relevance is determined by analyzing, for example, advertisement contents; advertisement title; contents and/or domain name of a Web page, to which the user is redirected when clicking on said advertisement; history and/or metadata (such as title, description, author name, update date, etc.) of said Web page; etc.

According to a preferred embodiment of the present invention, one or more software components 527 can comprise natural language processing algorithms and techniques for determining the relevance of the advertisement to users' search queries. By implementing these techniques, the advertisement contents; advertisement title; contents and/or domain name of a Web page, to which the user is redirected when clicking on said advertisement; history and/or metadata (such as title, description, author name, update date, etc.) of said Web page; and other parameters are analyzed, and then a relevance weight (RW) is assigned to the advertisement for one or more keywords or their synonyms (for which said advertisement is presented to a search engine user). Then, the corresponding PPR click cost or PPR impression cost is calculated.

According to another preferred embodiment of the present invention, one or more software components 527 can comprise artificial intelligence algorithms and techniques for determining the relevance of the advertisement to users' search queries. The artificial intelligence can be based, for example, on neural computing (neural networks); can implement different decision making algorithms and techniques; can implement case-based reasoning; can implement natural language processing pattern matching, syntactic and semantic analysis, neural computing, conceptual dependency, etc.) and speech/audio recognition and understanding algorithms and techniques; can implement visual recognition algorithms and techniques; can use intelligent agents; can implement fuzzy logic, genetic algorithms and techniques, automatic programming, computer vision, and many others. Further, one or more software components 527 can implement various machine learning algorithms and techniques.

According to a preferred embodiment of the present invention, the relevance weight of the advertisement to users' search queries is determined in real-time. When the user searches a Web site (which can be a search engine Web site or any other conventional Web site) by using one or more keywords, the software component provided within server 525 of the search engine provider determines in real-time the relevance weight of each advertisement to said one or more keywords and/or their synonyms. Further, the meaning of said one or more keywords can be determined by using conventional natural language processing and/or artificial intelligence algorithms and techniques, determining by this way in real-time the relevance weight of the advertisement to said one or more keywords. For example, if the advertisement is related to tennis games, and the user makes a search by using keywords “inexpensive racket”, then by understanding that the term “racket” is related to the tennis games, the corresponding relevance weight is determined.

According to another preferred embodiment of the present invention, within said Web site (which can be a search engine Web site or any other conventional Web site), is provided a database comprising a plurality of dictionaries for each category or subcategory, to which each advertisement of assigned. If the user searches the Web site (or searches the data network by means of said Web site, if said Web site is a search engine) by using one or more keywords that appear in the dictionary within the plurality of said dictionaries, then the relevance of the advertisement to said dictionary (to the category/subcategory to which said dictionary is related) is determined. Finally, the PPR cost is determined accordingly. It should be noted that the advertisement can be assigned to its corresponding one or more category/subcategories by the advertiser himself by indicating the corresponding category/subcategory within field 210 (FIG. 2) and/or by means of software component 527, provided within server 525 of the search engine provider, by analyzing one or more predefined parameters of the advertisement (advertisement title, advertisement contents, contents and/or domain name of a Web page, to which the user is redirected when clicking on said advertisement; history and/or metadata (such as title, description, author name, update date, etc.)). For example, it is supposed that the advertisement is related to the category “Education” and to subcategories “GRE® test preparation”, “GMAT® test preparation”, “SAT® test preparation” and “PCAT® test preparation”. If the user searches the Web site (in which the advertisement may be placed) by using the keywords “business test”, then software component 527 determines that the term “business test” is within the dictionary of the subcategory “GMAT® test preparation”. After that, the corresponding relevance weight of the advertisement to said keywords “business test” is determined by considering a plurality of factors (parameters), such as whether the advertisement contents/advertisement title contains said term, or its synonyms, or related terms; whether the contents and/or domain name of a Web page, to which the user is redirected when clicking on said advertisement, contain said term, or its synonyms, or related terms; whether history and/or metadata (such as title, description, author name, update date, etc.) of said Web page, to which the user is redirected when clicking on said advertisement, contain said term, or its synonyms, or related terms; etc. Finally, the PPR cost of the advertisement is determined according to the relevance weight.

According to still another preferred embodiment of the present invention, near each advertisement within Sponsored Links list 110 (FIG. 1) a corresponding relevance weight is indicated, showing to search engine users how much the advertisements are related to their search queries. The more the advertisement is related, indicating said relevance weight near it, then the greater is the probability that said users will click on it. According to still another preferred embodiment of the present invention, the advertisements can be highlighted (or colored) for attracting users' attention. The advertiser may be required be add a predefined sum of money if he wishes to highlight his advertisement or to color it. For example, the most relevant advertisement can be provided in a red color, the less relevant advertisement—in a green color, the least relevant advertisement—in a blue color.

According to a further preferred embodiment of the present invention, the advertisers can select dimensions of their advertisements. For example, the advertisement(s) that has the greatest relevance weight to users' search queries can have large dimension (length and/or width), and the advertiser of said advertisement(s) does not need to pay additional cost for such large dimensions. For another example, the advertiser(s) of the advertisement(s) that has the lowest relevance weight to users' search queries, is required to pay an additional cost for increasing a standard (default) dimension of said advertisement(s). For still another example, each advertiser can select the desired dimensions of his advertisement and to pay for that accordingly (the larger the dimensions are, the greater is the cost).

According to a preferred embodiment of the present invention, a program storage device(s) readable by machine is provided, which tangibly embodies a program of instructions executable by the machine to perform methods of the present invention, such as a method of PPR pricing of advertisements to be presented within a document to users, according to their relevance to user's search query. In addition, said program of instructions executable by the machine performs a method of presenting advertisements to users in a specific order within a document, according to their relevance to user's search query. Further, said program of instructions executable by the machine performs a method of presenting advertisements to users in a specific order, according to their relevance to the contents of a document on which they are presented.

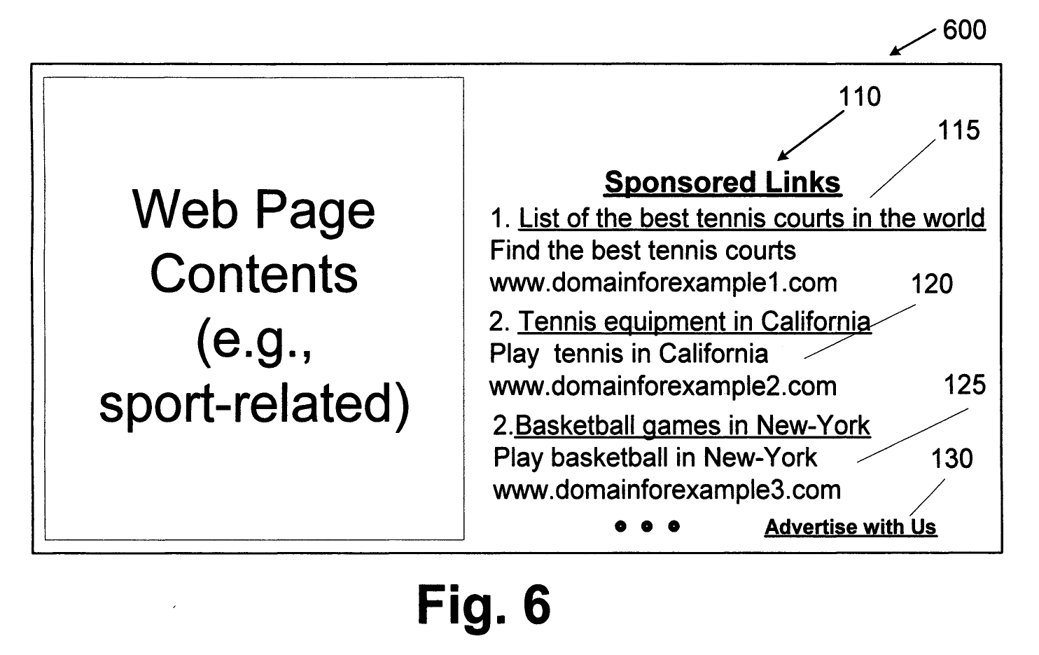

FIG. 6 is another schematic illustration of a method for the PPR advertising over a data network, according to another preferred embodiment of the present invention. The advertisement placed by the advertiser within a search engine Web site (or any other conventional Web site) as described in FIG. 1 to FIG. 5, can be further displayed on 3-rd party Web sites (pages), such as Web site (page) 600. The owner of a 3-rd party Web page 600, wishing to place advertisements within his Web page 600, can open an account in said search engine Web site and to sign for such service. When a user clicks on each advertisement displayed within said Web page 600, the owner of said Web page 600 receives a predefined sum of money from the search engine Web site provider. According to another preferred embodiment of the present invention, the owner of said Web page 600 can receive a predefined sum of money for each impression of the advertisement to the user (even if the user does not click on the advertisement). According to still another preferred embodiment of the present invention, the owner of Web page 600 can receive a fixed sum of money for advertising on his Web site (e.g., for each advertisement displayed on his Web site he can receive $1 per hour).

The software component, provided within server 525 (FIG. 5) of the search engine provider, determines for each 3-rd party Web site (page) signed for such service, what is its corresponding category/subcategory. Then, one or more advertisements related to the determined Web page category/subcategory are displayed on said Web page.

According to a preferred embodiment of the present invention, when placing an advertisement on a search engine Web site the advertiser selects one or more search queries (keywords) for which his advertisement will be displayed. Then, a software component provided within server 525 (FIG. 5) of the search engine provider automatically determines, according to the one or more predefined parameters (such as the above selected keywords (or their synonyms or related terms); advertisement contents; advertisement title; contents and/or domain name of a web page to which the user is redirected when clicking on said advertisement, etc.), the relevance weight of the selected keywords and of the advertisement to the contents of related 3-rd party Web sites (in which the advertisement may be presented). Then, the corresponding PPR (Pay Per Relevance) cost is determined (e.g., is determined how much the advertiser will pay each time the user clicks on his advertisement, or how much the advertiser will pay for each impression of the advertisement to the user). The more the above selected keywords and the advertisement are relevant (related) to the contents of the 3-rd party Web site (page), then the more the advertiser will pay for each click on his advertisement and the higher his advertisement can be located within Sponsored Links list 110. As a result, the advertiser pays per relevance (PPR) of his advertisement to the Web site contents. For example, if Web page 600 is a sport-related Web site, but it is mostly related to tennis courts, then advertisement 115 is the most related to the contents of said Web page 600, advertisement 120 is less related and advertisement 125 is the least related. As a result, the PPR click cost for advertisement 115 can be $0.5; the PPR click cost for advertisement 120 can be $0.3; and the PPR click cost for advertisement 125 can be $0.05.

According to another preferred embodiment of the present invention, the relevance weight of the advertisement to Web site contents is determined in real-time. Software component 527 provided within server 525 (FIG. 5) determines in real-time the relevance weight of the advertisement to the Web site contents.

Further, when user press on the “Advertise with Us” link 130, he is redirected to a process for opening an account in the search engine Web site (or in any other conventional Web site) and for signing for such service (similarly to what is described in FIG. 2 to FIG. 4).

According to a preferred embodiment of the present invention, the relevance of keywords (or their synonyms or related terms), selected by the advertiser within text field 210 (FIG. 2), and of the advertisement to the contents of 3-rd party Web page (site) can be determined according to one or more categorized scores of said Web page. Said categorized scores indicate the category and/or subcategory, to which said Web page is assigned (assigning the one or more categorized scores to a document stored within a database over a data network is described in the patent application PCT/IL2006/001427).

It should be noted that for placing advertisements (Sponsored Links) on the 3-rd party Web site, the webmaster (owner) of such Web site integrates a predefined software code (such as the JavaScript™ code, etc.) within a corresponding Web page wherein he wishes to place the advertisements. Then, the Sponsored Links list 110 (provided by a search engine Web site, wherein advertisers have signed for 3-rd party advertising services) is displayed said Web page. In addition, it should be noted that the advertiser can define how many links will be displayed within each Sponsored Links list and how many Sponsored Links lists will be displayed within each Web page.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

What is claimed is:

1. A method of pricing advertisements to be presented within a document, according to their relevance to user's search query, comprising:
a) receiving from an advertiser at least one keyword, for which his advertisement to be presented to said user, or receiving and processing said user's search query that contains at least one keyword;
b) determining the relevance weight of said advertisement to said at least one keyword, according to at least one predefined parameter; and
c) pricing said advertisement according to the determined relevance weight.

2. The method according to claim 1, further comprising selecting the at least one predefined parameter from one or more of the following:
a) advertisement contents;
b) advertisement title;
c) contents and/or domain name of a Web page, to which the user is redirected when clicking on said advertisement;
d) domain name of a Web page, to which the user is redirected when clicking on said advertisement;
e) category and/or subcategory of a Web page, to which the user is redirected when clicking on said advertisement;
f) at least one categorized score of a Web page, to which the user is redirected when clicking on said advertisement;
g) history of said Web page;
h) metadata of said Web page;
i) an advertising category that is selected by the advertiser; and
j) advertising statistics.

3. The method according to claim 1, further comprising pricing the advertisement by determining a pay per relevance cost for each user's click on said advertisement.

4. The method according to claim 1, further comprising pricing the advertisement by determining a pay per relevance cost for each impression of said advertisement to the user.

5. The method according to claim 1, further comprising determining at least one synonym for each keyword and displaying the advertisements that are related to said synonym.

6. The method according to claim 1, further comprising performing natural language processing on the at least one predefined parameter for determining the relevance weight of the advertisement to the at least one keyword.

7. The method according to claim 1, further comprising placing the advertisement having a greater relevance weight above or below the advertisement having a smaller relevance weight.

8. The method according to claim 1, further comprising enabling each advertiser to select where within the document his at least one advertisement is placed.

9. The method according to claim 1, further comprising enabling each advertiser to select dimensions of his at least one advertisement.

10. The method according to claim 1, further comprising coloring the advertisements in different colors according to their relevance weight.

11. The method according to claim 1, further comprising categorizing the advertisement.

12. The method according to claim 1, further comprising categorizing user's search query.

13. The method according to claim 1, further comprising providing at least one category and/or subcategory, and building a dictionary of related terms for each category and/or subcategory.

14. The method according to claim 13, further comprising determining whether the user's search query is within the dictionary and then determining the relevance weight accordingly.

15. The method according to claim 1, further comprising dynamically changing the pricing of the advertisements.

16. A method of presenting advertisements to a user in a specific order within a document, according to their relevance to user's search query that contains at least one keyword, comprising:
a) receiving user's search query and processing it; and
b) displaying to said user at least two advertisements, which are related to said user's search query, in a corresponding order within said document according to the relevance weight of said advertisements to said user's search query, said relevance weight determined according to at least one predefined parameter.

17. The method according to claim 16, further comprising pricing the advertisements according to the determined relevance weight.

18. The method according to claim 16, further comprising selecting the at least one predefined parameter from one or more of the following:
a) advertisement contents;
b) advertisement title;
c) contents and/or domain name of a Web page, to which the user is redirected when clicking on said advertisement;
d) domain name of a Web page, to which the user is redirected when clicking on said advertisement;
e) category and/or subcategory of a Web page, to which the user is redirected when clicking on said advertisement;
f) at least one categorized score of a Web page, to which the user is redirected when clicking on said advertisement;
g) history of said Web page;
h) metadata of said Web page;
i) an advertising category that is selected by the advertiser; and
j) advertising statistics.

19. The method according to claim 16, further comprising pricing the advertisement by determining a pay per relevance cost for each user's click on said advertisement.

20. The method according to claim 16, further comprising pricing the advertisement by determining a pay per relevance cost for each impression of said advertisement to the user.

21. The method according to claim 16, further comprising determining at least one synonym for each keyword and displaying the advertisements that are related to said synonym.

22. The method according to claim 16, further comprising performing natural language processing on the at least one predefined parameter for determining the relevance weight of the advertisement to the at least one keyword.

23. The method according to claim 16, further comprising placing the advertisement having a greater relevance weight above or below the advertisement having a smaller relevance weight.

24. The method according to claim 16, further comprising enabling each advertiser to select where within the document his at least one advertisement is placed.

25. The method according to claim 16, further comprising enabling each advertiser to select dimensions of his at least one advertisement.

26. The method according to claim 16, further comprising coloring the advertisements in different colors according to their relevance weight.

27. The method according to claim 16, further comprising categorizing the advertisement.

28. The method according to claim 16, further comprising categorizing user's search query.

29. The method according to claim 16, further comprising providing at least one category and/or subcategory, and building a dictionary of related terms for each category and/or subcategory.

30. The method according to claim 29, further comprising determining whether the user's search query is within the dictionary and then determining the relevance weight accordingly.

31. The method according to claim 17, further comprising dynamically changing the pricing of the advertisements.

32. A method of presenting advertisements to a user in a specific order, according to their relevance to the contents of a document on which they are presented, comprising:
a) analyzing the document contents and determining at least two advertisements related to said contents;
b) determining the relevance weight of each of said at least two advertisements to said document contents, according to at least one predefined parameter; and
c) displaying on said document said at least two advertisements, in a corresponding order according to the determined relevance weight of each of said at least two advertisements to said document contents.

33. The method according to claim 32, further comprising pricing the advertisements according to the determined relevance weight.

34. The method according to claim 32, further comprising selecting the at least one predefined parameter from one or more of the following:
a) advertisement contents;
b) advertisement title;
c) contents and/or domain name of a Web page, to which the user is redirected when clicking on said advertisement;
d) domain name of a Web page, to which the user is redirected when clicking on said advertisement;
e) category and/or subcategory of a Web page, to which the user is redirected when clicking on said advertisement;
f) at least one categorized score of a Web page, to which the user is redirected when clicking on said advertisement;
g) history of said Web page;
h) metadata of said Web page;
i) an advertising category that is selected by the advertiser;
j) advertising statistics.

35. The method according to claim 32, further comprising pricing the advertisement by determining a pay per relevance cost for each user's click on said advertisement.

36. The method according to claim 32, further comprising pricing the advertisement by determining a pay per relevance cost for each impression of said advertisement to the user.

37. The method according to claim 32, further comprising placing the advertisement having a greater relevance weight above or below the advertisement having a smaller relevance weight.

38. The method according to claim 32, further comprising enabling each advertiser to select where within the document his at least one advertisement is placed.

39. The method according to claim 32, further comprising enabling each advertiser to select dimensions of his at least one advertisement.

40. The method according to claim 32, further comprising coloring the advertisements in different colors according to their relevance weight.

41. The method according to claim 32, further comprising categorizing the advertisement.

42. The method according to claim 32, further comprising providing at least one category and/or subcategory, and building a dictionary of related terms for each category and/or subcategory.

43. The method according to claim 42, further comprising determining whether the user's search query is within the dictionary and then determining the relevance weight accordingly.

44. The method according to claim 33, further comprising dynamically changing the pricing of the advertisements.

45. A server configured to provide advertisements according to users' search queries, each of said search queries containing at least one keyword, said server comprising:
a) an advertisements database for storing a plurality of advertisements, each to be provided to the user according to his search query containing at least one keyword; and
b) a pay per relevance software component for determining, according to at least one predefined parameter, a relevance weight of each advertisement stored within said advertisements database to said at least one keyword, and for pricing said each advertisement according to the determined relevance weight.

46. The server according to claim 45, further comprising a search data database for storing a plurality of documents to be provided as search results to users' search queries.

47. The server according to claim 46, further comprising at least one additional software component for performing at least one of the following:
a) managing the search data database;
b) receiving and processing users' search queries; and
c) providing to said users corresponding search results from said search data database.

48. The server according to claim 45, further comprising at least one additional software component for managing the advertisements database and for processing advertisements to be presented to the users.

49. The server according to claim 45, further comprising a billing unit for enabling billing of advertisers for providing their advertisements to users, according to the determined relevance weight.

50. The server according to claim 45, wherein the at least one predefined parameter is selected from one or more of the following:
a) advertisement contents;
b) advertisement title;
c) contents and/or domain name of a Web page, to which the user is redirected when clicking on said advertisement;
d) domain name of a Web page, to which the user is redirected when clicking on said advertisement;
e) category and/or subcategory of a Web page, to which the user is redirected when clicking on said advertisement;
f) at least one categorized score of a Web page, to which the user is redirected when clicking on said advertisement;
g) history of said Web page;
h) metadata of said Web page;
i) an advertising category that is selected by the advertiser; and
j) advertising statistics.

51. The server according to claim 45, wherein for pricing the advertisement, a pay per relevance cost for each user's click on said advertisement is determined.

52. The server according to claim 45, wherein for pricing the advertisement, a pay per relevance cost for each impression of said advertisement to the user is determined.

53. The server according to claim 45, wherein at least one synonym is determined for each keyword.

54. The server according to claim 53, wherein said server enables displaying the advertisements that are related to the at least one synonym.

55. The server according to claim 45, wherein the natural language processing is performed on the at least one predefined parameter for determining the relevance weight of the advertisement to the at least one keyword.

56. The server according to claim 45, wherein said server provides, within a sponsored links list, the advertisement having a greater relevance weight above or below the advertisement having a smaller relevance weight.

57. The server according to claim 45, wherein said server enables each advertiser to select where within a sponsored links list his at least one advertisement is placed.

58. The server according to claim 45, wherein said server enables each advertiser to select dimensions of his at least one advertisement.

59. The server according to claim 45, wherein said server enables coloring the advertisements in different colors according to their relevance weights.

60. The server according to claim 45, wherein said server enables categorizing each advertisement to its corresponding category and/or subcategory.

61. The server according to claim 45, wherein said server enables categorizing the user's search query to its corresponding category and/or subcategory.

62. The server according to claim 45, wherein said server enables providing at least one category and/or subcategory, and enables building a dictionary of related terms for each category and/or subcategory.

63. The server according to claim 62, wherein said server determines whether the user's search query is within the dictionary, and then determines the corresponding relevance weight.

64. The server according to claim 45, wherein said server enables dynamically changing the pricing of each advertisement.

65. A system configured to price advertisements according to their relevance to user's search queries, each of said search queries containing at least one keyword, said system comprising:
a) a plurality of computers connected to a Web site over a data network for enabling users to search said Web site or said data network by using at least keyword; and
b) a server configured to provide advertisements to said users according to their search queries, each of said search queries containing at least one keyword, said server comprising:
b.1. an advertisements database for storing a plurality of advertisements, each to be provided to the user according to his at least one keyword; and
b.2. a pay per relevance software component for determining, according to at least one predefined parameter, a relevance weight of each advertisement stored within said advertisements database to said at least one keyword, and for pricing said each advertisement according to the determined relevance weight.

66. A program storage device readable by machine, tangibly embodying a program of instructions executable by the machine to perform a method of pricing advertisements to be presented within a document, according to their relevance to user's search query, said method comprising:
a) receiving from an advertiser at least one keyword, for which his advertisement to be presented to said user, or receiving and processing said user's search query that contains at least one keyword;
b) determining the relevance weight of said advertisement to said at least one keyword, according to at least one predefined parameter; and
c) pricing said advertisement according to the determined relevance weight.
